(19) United States
(12) Patent Application Publication
(10) Pub. No.: US 2007/0080327 A1
(43) Pub. Date: Apr. 12, 2007

(54) Luminescent material

(75) Inventors: Tadashi Ueda, Fukui-shi (JP); Seikoh Yamauchi, Tokyo (JP); Jiro Kanamori, Ikoma-shi (JP); Yoshisada Hayashi, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: T. Chatani Co., Ltd., Osaka-shi (JP)

(21) Appl. No.: 11/246,205

(22) Filed: Oct. 11, 2005

(51) Int. Cl. C09K 11/08

(52) U.S. Cl. 252/301.4 R; 252/301.6 S; 252/301.6 R; 252/301.4 S

(57) ABSTRACT

An inorganic EL element with a high luminance and an improved life can be produced by using a luminescent material which can be produced by an explosion method.

### BACKGROUND OF THE INVENTION

1. Field of the Invention

This invention relates to a luminescent material used for an electroluminescent element, and more specifically, a luminescent material comprising an inorganic compound.

2. Description of the Related Art

Electroluminescent (hereinafter referred to as EL) elements are developed in various directions since EL elements can be used in applications like flat panel display, and they have unique merits of low power consumption and self luminescence. EL elements are broadly divided into organic EL elements and inorganic EL elements depending on the luminescent material used. The inorganic EL elements are further divided into dispersion-type EL elements having the luminescent material dispersed in an inorganic-or organic binder, and thin film-type EL element using a film of crystallized luminescent material.

Well known luminescent materials that have been used in producing the inorganic EL element include those comprising a crystal such as ZnS, SrS, or BaAl₂S₄ having introduced therein a metal ion serving the luminescent center such as Cu, Mn, or a rare earth metal such as Eu and Pr. Such a luminescent material is dispersed in a dielectric material which also serves a binder to thereby form a light emitting layer having a thickness of 20 to 100 μm, and a dielectric layer is disposed on this luminescent material layer to thereby increase a dielectric strength voltage of the element and secure a stable operation. Electrodes (at least one of the electrodes being a transparent electrode) are then providedon opposite surfaces of this dual-layer structure. When the element is connected to an AC source and an increasing voltage is applied, EL luminescence starts to emit light when the electric field in the light emitting layer reaches almost 10⁶ V/cm.

Conventional luminescent materials so far available have been inferior in either luminance or life compared with other illumination devices (JP-A No. 2002-241753). An exemplary method of increasing the luminance is to increase the voltage applied. Increasing the voltage, however, is associated with the tendency of a reduced life, and as a consequence, choosing of “luminance or life” has been necessary.

Inview of the situation as described above, an object of the present invention is to provide a luminescent material which is simultaneously provided with the luminance and the life at a high level.

### SUMMARY OF THE INVENTION

In order to achieve such an object, the present invention provides a luminescent material which can be produced by an explosion method, and this luminescent material preferably comprises an inorganic compound.

The present invention also provides an inorganic EL element produced by using such a luminescent material.

The luminescent material of the present invention enables production of an EL element having an improved luminance as well as an elongated life.

### BRIEF DESCRIPTION OF THE DRAWINGS

FIG. 1 is a schematic view of a highly pressure resistant reaction vessel;

FIG. 2 is an exploded view of a reaction chamber of the highly pressure resistant reaction vessel; and

FIG. 3 is a cross-sectional view of the EL element used in the Example of the present invention.

### DETAILED DESCRIPTION OF THE INVENTION

Next, the present invention is described in detail.

The luminescent material of the present invention is the one which can be produced by an explosion method. The explosion method is a method in which a luminescent material is synthesized by using energy of heat, light, and/or shock wave (pressure) generated in the explosion of an explosive or powder such as TNT or powder (hereinafter generally referred to as an explosive) that has been placed in a pressure-resistant container with the starting materials of the luminescent material. The reason for the excellent properties of the luminescent material of the present invention obtained by the explosion method is estimated to be the energy state of the metal ion at the luminescent center which is different from the conventional luminescent materials due to instantaneous high temperature, light emission and/or shock wave produced by the explosion. However, particulars of the mechanism for the development of such favorable properties are still unknown. Accordingly, any luminescent material which may express excellent properties similar to those of the present invention by the mechanism equivalent to the luminescent material produced by the explosion method including the one produced by a method other than the explosion method are of course within the scope of the present invention.

The explosive used in the explosion method is not limited as long as energy sufficient for the reaction is produced. Exemplary explosives include TNT and black powder.

For the matrix substance of the luminescent material, those known in the art such as metal sulfide and metal oxide, for example, ZnS, SrS, BaAl₂S₄, and Ga₂O₃ can be used.

For the metal ion which serves the luminescent center, a metal ion, for example, a transition metal such as Cu and Mn or a rare earth metal such as Eu and Pr may be used. Such metal ion may be supplied in the explosion method in the form of an oxide, a sulfate, a nitrate, and the like.

Other starting materials used in the explosion methodincludesulfurfor adjusting a compositional ratio, an additive containing the element added to adjust the luminescent properties, and flux such as NaCl.

A crystal system of the mixture obtained by the explosion method may be converted by a method such as reheating or ball milling to obtain the luminescent material of the present invention. Mixing of the powder of the mixture produced in the explosion with a powder of a compound semiconductor such as GaAs or InP is sometimes effective in improving the properties of the resulting luminescent material.

### EXAMPLES

<Sample A>

Sample A which constitutes the Comparative Example of the present invention is prepared by a conventional method (JP-A No. 2005-126465) as described below. 7 g of zinc sulfate, 0.5 g of copper chloride, and 0.5 g of copper sulfate are mixed, and the mixture is calcined at 800° C. for 40 minutes in a quartz hearth. After cooling, the mixture is washed in glacial acetic acid, and then in deionized water, and further in aqueous solution of potassium prussiate. The mixture is further washed in deionized water and dried.

Sample B and Sample C which are the luminescent materials of the present invention are produced by the procedure as described below, and sieved by a separator to produce the luminescent material of Sample A.

<Explosion method>

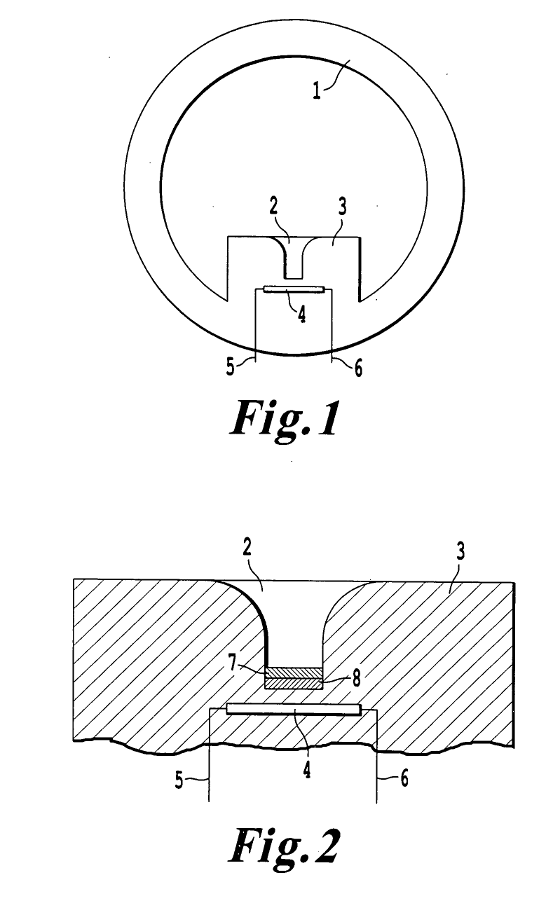

A luminescent mixture produced by mixing 100 g of zinc sulfide, 0.27 g of manganese sulfate, 0.5 g of zinc oxide, 3 g of barium fluoride, 3 g of magnesium chloride, 0.012 g of iridium chloride, and 2 g of sodium chloride is weighted, and used as a luminescent material mixture 8, and this luminescent material mixture 8 is placed in a reaction chamber 2 shown in FIG. 2 of a reaction vessel 1 shown in FIG. 1. Next, 32 g of TNT (the amount calculated for 500 atm.) is added as an explosive 7, and the highly pressure-resistant reaction vessel 1 is sealed. After reducing the pressure to 0.01 mmHg, a current is passed through a heater 4 to heat the reaction chamber 2 to a temperature of 450° C. to induce explosion of the TNT to thereby form calcined cake. The calcined cake is then removed from the reaction vessel 1, cooled, washed with deionized water to remove flux, and dried.

<Sample B>

The calcined cake produced by the explosion method is pulverized in a pulverizer/separator to produce a powder having a particle size of 5to 20 μm. The resulting powder is placed in a silica tube reaction vessel of a cylindrical electric furnace, and calcined in a nitrogen atmosphere at a temperature of about 700° C. for about 8 hours inthe silica tube. The resulting product is washed with glacial acetic acid to remove excessive compounds, flux, and impurities, and further with deionized water.

The product is then filtered, dried at about 180° C, and cooled, and sieved in a separator to produce the luminescent material of Sample B.

<Sample C>

The calcined cake produced by the explosion method is pulverized in a pulverizer/separator to produce a powder having a particle size of 5 to 20 μm. A weighed mixture of 15 g of the powder and 5 mg of gallium arsenide having a particle size of 1 to 3 μm is placed in a plastic bottle, and stirred in a mechanical stirrer for 20 minutes. The resulting powder mixture is placed in a silica tube reaction vessel of a cylindrical electric furnace, and calcined in a nitrogen atmosphere at a temperature of about 700° C. for about 8 hours in the silica tube. The subsequent procedure of Sample B is repeated to produce the luminescent material of Sample C.

<Measurement of luminance>

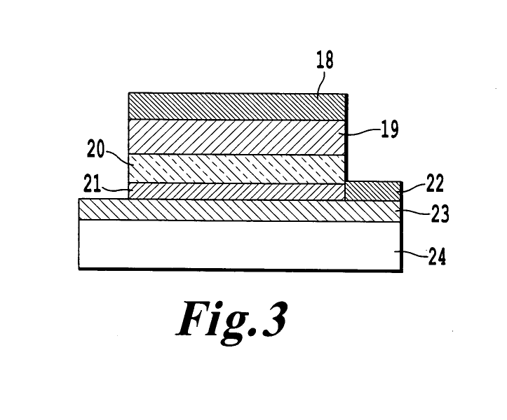

An EL element is constituted by using Sample B and Sample C of the present invention and Sample A for a comparison purpose, and the luminance is measured over time (see Table 1). The EL element has the constitution as shown in FIG. 3. A light emitting layer is formed by obtaining luminescent particles containing not less than 80% of particles of 12 to 18 μm by classifying the particles of Samples A to C, and coating the particles by silk screening on the barium titanate layer disposed on an electrode. A barium titanate layer is disposed on the light emitting layer, and an electrode is disposed on the barium titanate layer to constitute an AC luminescent device.

<Results>

The luminance shown indicated in Table 1 are the values measured after 0 hours, 24 hours, and 100 hours. The EL element is applied with a DC voltage of 8 kHz. The voltage applied is 280 V.

In the case of Sample B within the scope of the present invention, initial luminance is about twice higher than that of the Comparative Example. In addition, luminance is maintained at 80% of the initial luminance even after 100 hours in the case of Sample B in Example 1 while the luminance decreases to less than a half of the initial luminance after 100 hours in the case of Comparative Example. Sample C in Example 2 exhibits remarkably improved properties, and the initial luminance is about 8 times higher than that of the Comparative Example.

With regard to Sample C, a different test has been conducted (Example 3). In this test, the luminance is maintained at a constant level for 100 hours by changing the voltage applied. As a consequence, no change in the luminance is observed although 315 V after 24 hours and 330 V after 100 hours are necessary. When the test is continued, the luminance stabilizes after 120 hours, and no time-dependent change of the luminance has been observed for the subsequent period of more than 1000 hours.

TABLE 1

| | | Luminance (cd/m²) | | |
|---|---|---|---|---|
| | Luminescent | | After 24 | After 100 |
| | material | Initial | hours | hours |
| Comparative | Sample A | 485 | 322 | 221 |
| Example | | | | |
| Example 1 | Sample B | 1002 | 865 | 826 |
| Example 2 | Sample C | 4085 | 3681 | 2984 |
| Example 3 | Sample C | 4085 | 4026 | 4026 |

What is claimed is:

1. A luminescent material which can be produced by an explosion method.

2. The luminescent material according to claim 1, comprising an inorganic compound.

3. An inorganic EL element produced by using the luminescent material of claim 2.
